(19) United States
(12) Patent Application Publication
(10) Pub. No.: US 2003/0141730 A1
(43) Pub. Date: Jul. 31, 2003

(54) Pallet-pull

(76) Inventors: Randy Richard Sawtelle, Brooksville, FL (US); Michael Jerome Kallas, Asheville, NC (US)

Correspondence Address: Randy R. Santelle, 12341 Ruffed Grouse Rd., Brooksville, FL, 34614-1918, US

(21) Appl. No.: 10/353,516

(22) Filed: Jan. 29, 2003

Related U.S. Application Data
(60) Provisional application No. 60/353,087, filed on Jan. 30, 2002.

(51) Int. Cl. B66C 1/62

(52) U.S. Cl. 294/82.1

(57) ABSTRACT

The Pallet-Pull presents a method for moving and pulling shipping pallets. Such pallets can be made of many different materials and sizes. The device can be attached to any forklift or any thing capable of pulling, such as but not limited to front end loaders, forklifts, farm tractors, and any machine capable of pulling laterally. The device is designed to work in conjunction with a steel chain. Said chain is attached to the device. The chain can be attached or extended by other chains or cables to form the needed length to extract or move pallet. This chain by its very nature allows attachment to a wide Variety of equipment. The device is placed inside the frame work of the pallet, and is held in place by lateral pressure from pulling equipment. The device applies friction to 2 places on the pallet creating a firm hold for lateral pulling. Pallet is then pulled to desired placement, and the device can easily be removed.

### CROSS REFERENCE TO PROVISIONAL PATENT APPLICATION

The benefit of the U.S. Provisional Application No. 60/353,087 Jan. 30, 2002, is claimed.

### BACK GROUND OF THE INVENTION

Shipping of materials and equipment and general freight from one place to another has been done for centuries. In relatively recent times this has been accomplished by placing the freight on pallets to facilitate there handling by forklifts. To use a pallet to move materials, the pallet is placed on a substantially flat, stable surface (e.g., substantially level ground, industrial storage shelves, etc,) and the materials to be moved are then placed on the pallet. The prongs of a forklift are then inserted into the slots defined by the pallet and the forklift may then lift the pallet and the materials thereon and move them to another location. This process enables the user to steadily lift and move loads of material that would otherwise be far too heavy and/or cumbersome. It also allows shipments to be organized in such a way that all freight headed to one place stays together.

However, in some instances, a suitable forklift may be unavailable to lift and move pallets or may be an impractical means of performing a particular material handling task involving pallets. Such instances may be no platform or dock that a forklift can rain the necessary access to either the shipping container (i.e.; semi tractor trailer, container shipping box). Forklifts generally have to enter a freight hauling container to remove materials not accessible from just a few feet in. They must travel the full length of the container to remove all of the pallets of freight. Other situations may arise where a pallet is inaccessible by a forklift and therefore can not be moved by it. In both situations the device can be inserted into the same slots that the forklift was to use thereby allowing the pulling or moving of the pallet to a more convenient or accessible location in which the forklift can carry out the rest of the task. By the use of extending chains or cables, etc. the device can be used to the full length of the shipping container. So the present invention provides an apparatus that enables the use of pallets even in these circumstances, thereby reducing downtime, inefficiencies, and other costs associated with forklift unavailability or impracticality.

### SUMMARY OF THE INVENTION

Briefly, this invention acts as a aid to removing and or placing shipping pallets. It facilitates this by being inserted into the pallets openings, with the combined force developed by the pulling equipment, secures itself to both the bottom slat and the horizontal frame work, allowing pulling equipment to pull the pallet into a more desirable position.

Advantageously, this allows many different ways that a pallet can be moved regardless of the location of the pallet and or available forklifts or access platforms. Some small companies' receiving freight do not have a platform or a forklift. The device thereby makes a simple and convenient way to gain access to the freight on the pallet.

The Pallet-Pull is made of, but not limited to heavy steel. It has a heavy chain, or a ring welded or formed into it to allow other chains or cables to be attached to the Pallet-Pull.

### BRIEF DESCRIPTION OF THE DRAWINGS

While the novel features of the invention are set forth with particularity in the append claims, the invention both as to organization and content, will be better understood and appreciated from the following detailed and description, taken in conjunction with the drawings and pictures which:

FIGS. 1 and 2 are color photographs of two views of a pallet pulling apparatus according to the embodiment of the invention, with a chain attached thereto;

FIGS. 3 and 4 are color photographs of the two views of the pallet pulling apparatus shown in FIGS. 1 and 2 engaging a pallet, these views taken from the side of the pallet engaging the apparatus.

FIG. 5 is a color photograph of the pallet pulling apparatus shown in FIGS. 1 and 2 engaging a pallet, this view taken from the side of the pallet opposite the side engaging the apparatus.

FIG. 6 is an overall top view detailed drawing with sides denoted by letters.

FIG. 7 is a detailed drawing end view side C as relative to FIG. 6

FIG. 8 is a detailed drawing right view side B as relative to FIG. 6

### DETAILED DESCRIPTION

Although the structure of pallets and the methods of their use are well-known to those of ordinary skill in the art of material handling and related fields, a discussion of these topics follow in order to describe the content of the present invention

A pallet is a platform having a major load-engaging surface and a support surface substantially parallel thereto, the load-engaging surface and the support surface each being defined by a plurality of space-apart slats. The load-engaging surface and the support surface of the standard pallet are separated by a plurality of substantially parallel cross braces formed by another plurality of spaced-apart slats. Cross braces are included in the standard pallet with as many as needed to adequately hold the slats and the desired weight of the freight it is to carry. The positioning of the cross braces, together with the load-engaging and support surfaces, define at least two large, substantially rectangular slots, which are typically used to receive the prongs of a forklift. However, the present invention assumes the unavailability or impracticality of a suitable forklift and therefore uses the slots defined by the pallet in a different manner.

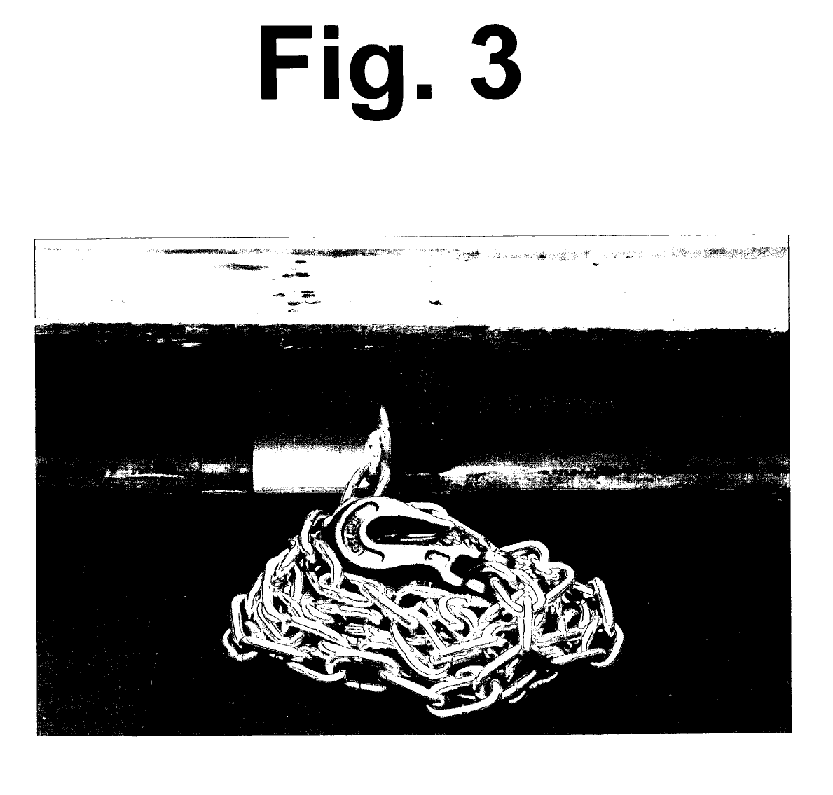

Although the dimensions and building materials of pallets may vary dramatically. The standard pallet is 4 feet wide, 4 feet long, and 6 Inches high and made out of wood. The boards of the load-engaging and support surface of the standard pallet are 1 inch thick and 4 inches wide (i.e., 1″ by 4″ boards), and the boards of the cross braces of such a pallet are 2 inches thick and 4 inches wide (i.e., 2″ by 4″ boards). In the standard pallet, the cross braces are oriented to space apart the major load-engaging surface from the support surface by 4 inches high. FIGS. 3,4, and 5 provide fragmentary views of the standard pallet.

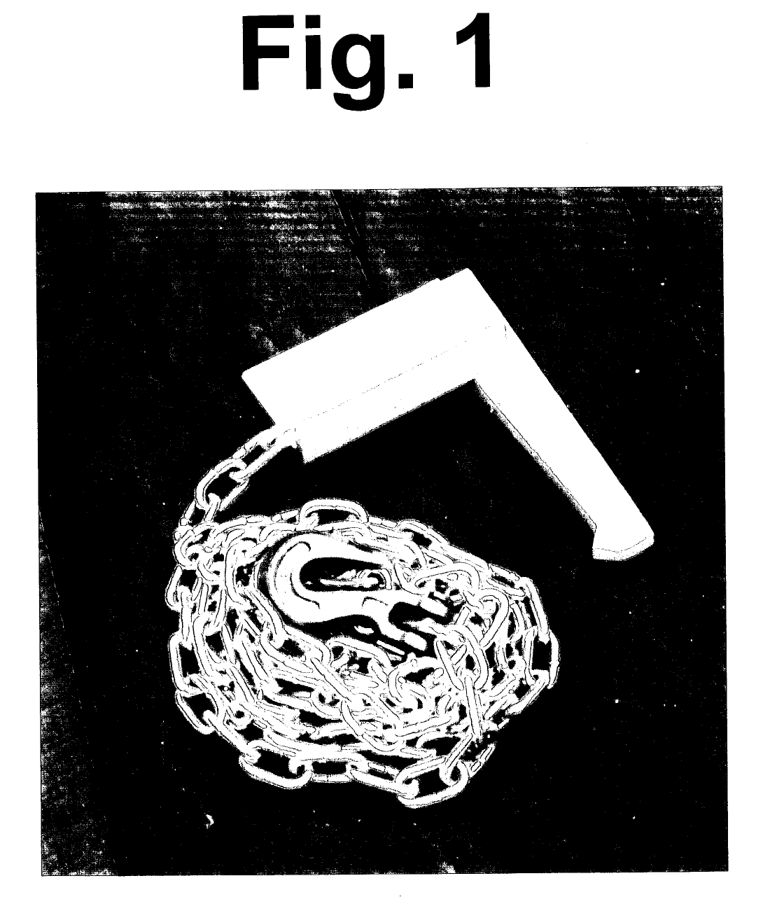

Referring now to the drawings, a pallet pulling apparatus according to the embodiment of the invention is shown in FIGS. 1, 2, 7. The apparatus is shown with a chain attached thereto. In the illustrated embodiment, the apparatus is formed of yellow painted steel. However any other suitably rigid material may be used to form the apparatus and any other appropriate paint or color may be used to coat the apparatus, although the apparatus will function properly without such a coating.

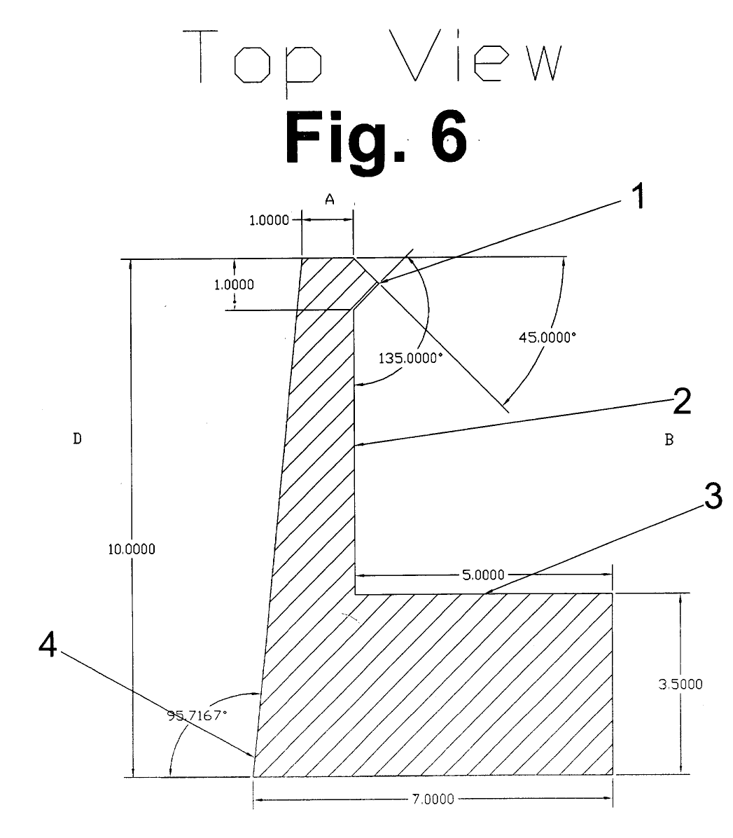

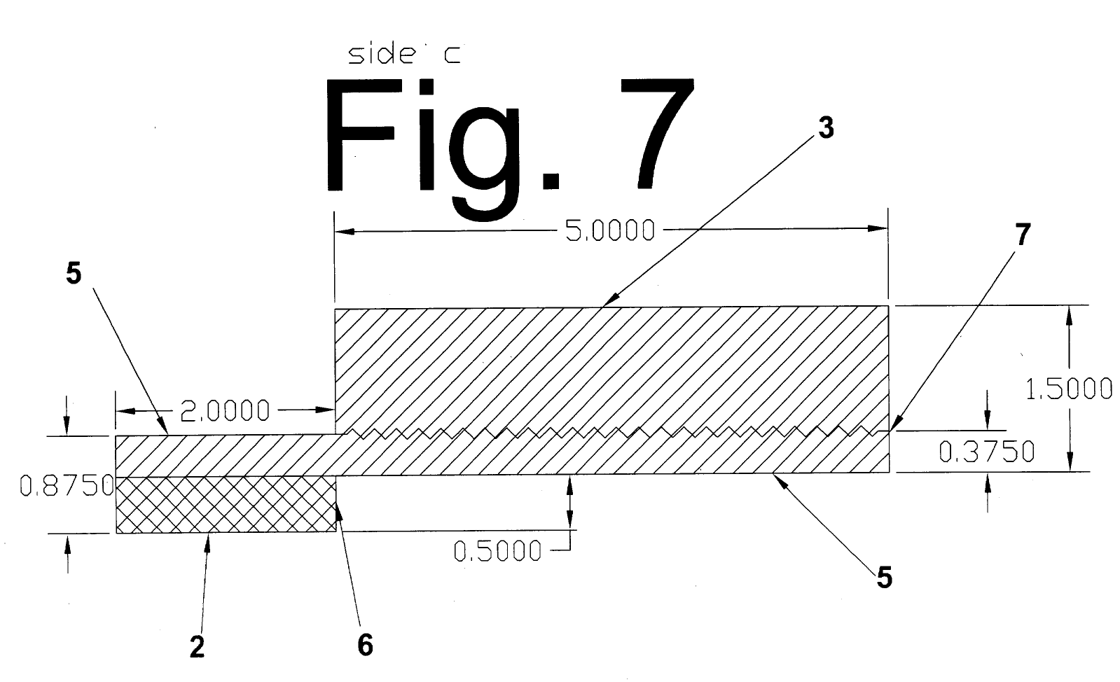

The pallet pulling apparatus is comprised but not limited to, 2 major plates, a substantially “L”-shaped stabilization plate FIGS. 7 & 8-#5 and a grapple arm plate FIG. 6, 7 & 8-#2 attached to or formed with the stabilization plate. The stabilization plate comprises a major panel and a minor panel formed in substantially perpendicular relation to each other. Resulting in the “L” shape FIGS. 7 & 8-#5. The major panel of the stabilization plate includes opposing major and minor surfaces. As show in the drawing, the minor panel of the stabilization plate extends upward from the minor surface of the major panel of the stabilization plate to form a fin in substantially perpendicular relation to both the grapple arm plate FIG. 6, 7 & 8-#2 and the major panel FIGS. 7 & 8-5 A 90% bend is depicted in FIG. 7-#7. The stabilization plate includes a proximal end adjacent to the grapple arm plate and a distal end. The grapple arm plate FIG. 6, 7 & 8-#2 is shaped as an elongate, tapered quadrilateral having a proximal end adjacent to the stabilization plate. FIG. 6-#4 shows the angle of the grapple arm plate in relation to the stabilization plate.

Optionally, a tooth is formed FIG. 6-#1 with the distal end of the grapple arm plate. The grapple arm plate comprises two opposing major surfaces, and upward-facing major surface and a downward-facing major surface. The proximal end of the major surface of the major panel of the stabilization plate, together with an adjacent area of the major panel of the stabilization plate, is attached to, fixedly secured to, or integrally formed with the proximal end of the upward surface of the grapple arm plate. The intersection of the stabilization plate and the grapple arm plate extends along approximately one-third the length of the upward-facing major surface of the grapple arm plate, beginning at the proximal end thereof. Such placing of the tooth FIGS. 6 & 8-#1 and the upturned stabilization plate FIGS. 7 & 8-#3 produce a pinching of opposing forces in effect grabbing the pallet in 2 areas.

Attached to or formed with a distal end of the minor panel of the stabilization plate is an eye for receiving a chain link or chain hook. The eye may be defined by a chain link attached to or formed with the minor panel of the stabilization plate, although other structures may define the eye. As shown in FIGS. 1 & 5 using the eye, a chain may be hooked or attached to the pallet pulling apparatus. The end of the chain opposite the end of the chain hooked or attached to the pallet pulling apparatus terminates in a hook or other suitable structure for securely attaching that opposite end of the chain to a vehicle such as tractor, forklift, etc. (not shown).

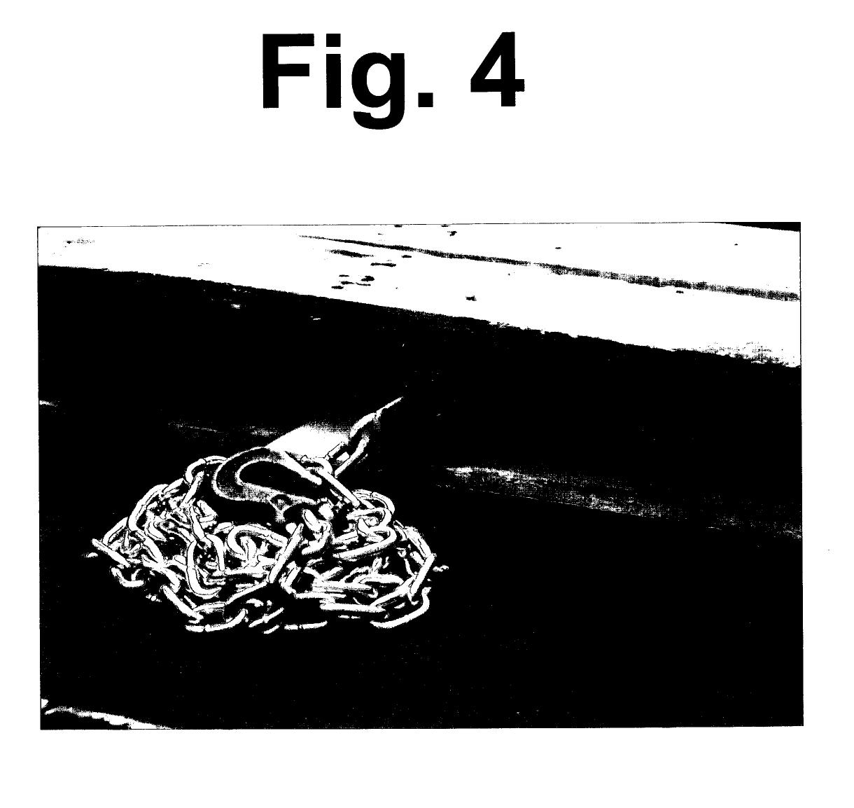

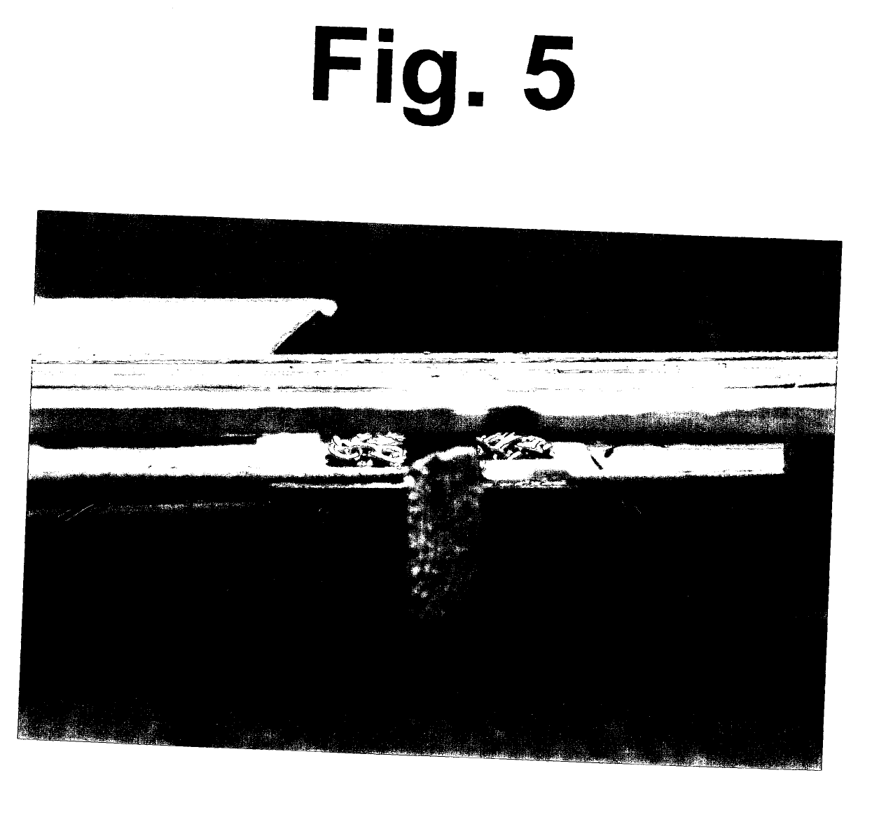

FIGS. 3, 4 & 5 illustrate the pallet pulling apparatus as it engages a pallet. As shown in these drawings, the grapple arm plate of the apparatus is inserted in one of the slots defined by the pallet. The apparatus is then positioned such that the fin of the stabilization plate FIGS. 7 & 8-# 3 engages a cross brace of the pallet (FIGS. 3 & 4) while the grapple arm plate engages an inward facing minor surface of one of the boards forming the support surface of the pallet (FIG. 5). The hook or other securing structure at the opposite of the chain extending from the apparatus is positioned to engage a vehicle (not shown) that will be used to pull the pallet. When the vehicle pulls the chain and the pallet pulling apparatus is thereby urged against the cross brace and the support surface board of the pallet to urge the pallet along the ground. Simultaneously, the stabilization plate of the apparatus imposes force on the cross brace of the pallet to keep the apparatus substantially stationary during use and to aid in the pulling of the pallet and insuring no breakage of the bottom slat. FIG. 7-#6 shows the face that holds onto the bottom slat of the pallet.

FIGS. 6 & 7 illustrate two different views of a pallet pulling apparatus according to an embodiment of the invention and lists the exact dimensions thereof. These dimensions are supplied merely for purpose of illustration, as the invention encompasses a wide range of potential dimensions and is therefore not limited by the disclosed dimensions. All distances are expressed in Inches and all angles are express in degrees.

A pallet pulling apparatus is described above. Various details of invention may be chanced without departing from its scope. Furthermore, the foregoing description of the invention and the best mode for practicing the invention are provided for the purpose of illustration only and for the purpose of limitation—the invention being defined by the claims.

### Key to Drawing Numbers

FIG. 1 is a picture of the complete Pallet-Pull with a Chain attached.

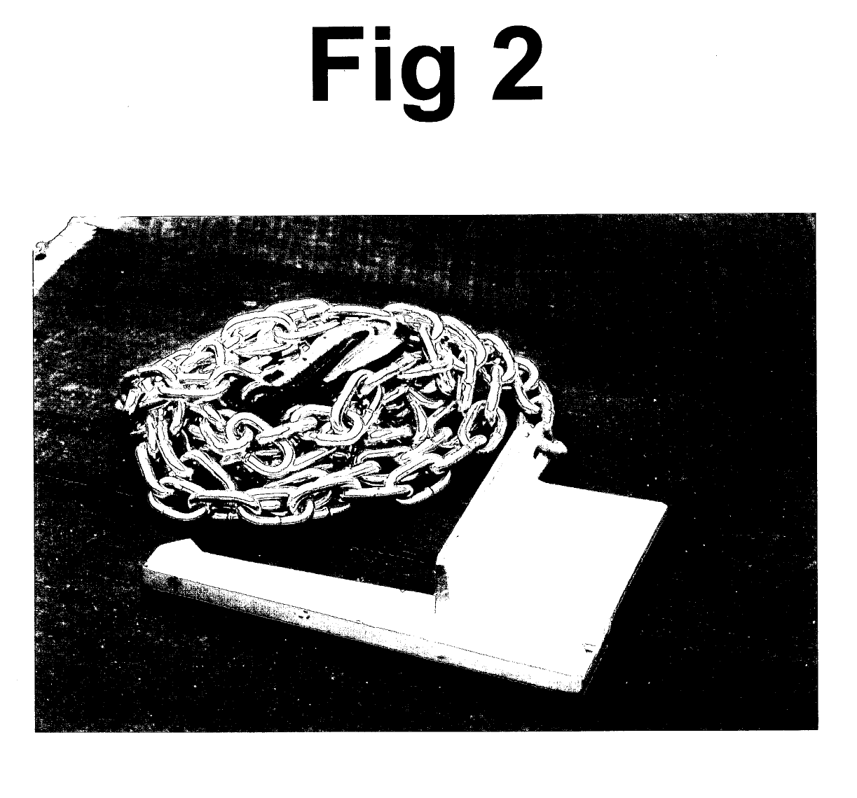

FIG. 2 is a picture of the back side of the complete Pallet-Pull with chain

FIG. 3 is a frontal view of the Pallet-Pull engaging the pallet.

FIG. 4 is a frontal view of the Pallet-Pull engaging the pallet from a different view.

FIG. 5 is a picture of the back side of the pallet and shows how the Pallet-Pull engages the bottom slat.

FIG. 6 is a Top View drawing of the Pallet-Pull with dimensions.

FIG. 7 is a drawing of the right side (side C) of the Pallet-Pull with dimensions.

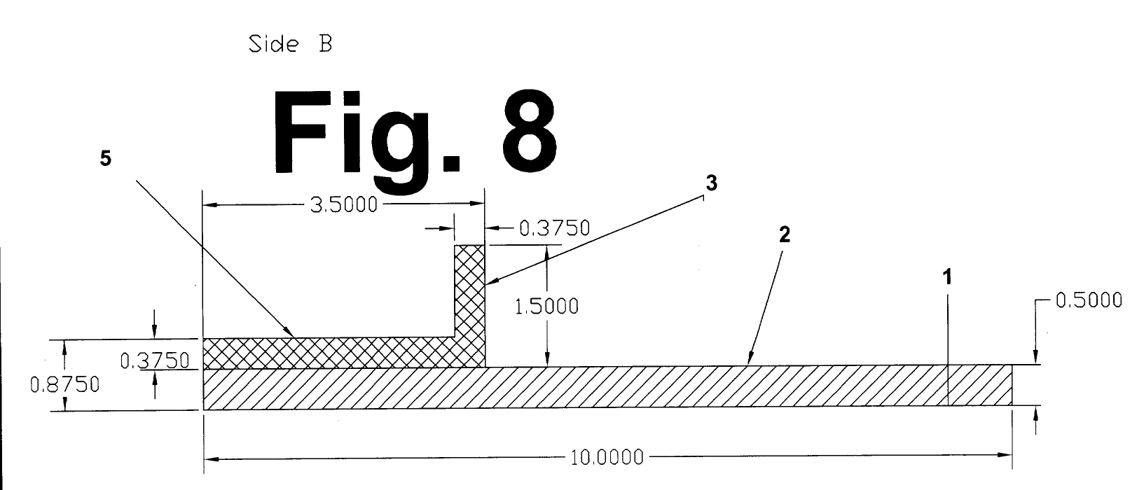

FIG. 8 is a drawing of the end (side B) of the Pallet-Pull with dimensions.

What is claimed is:

1. A method for removing shipping pallets. Providing a hook device in which pallets can be grabbed.
A) The method of claim 1 is a device that will put opposing forces on the bottom slat 1×4 and the upright supporting 2×4 in enough uniformity as to not break or harm the pallet or slats by its actions as it is being pulled.

2. A method for easily using a chain or cable to pull pallets from inaccessible spot without doing damage to the pallet.
